(19) United States
(12) Patent Application Publication
(10) Pub. No.: US 2025/0353766 A1
(43) Pub. Date: Nov. 20, 2025

(54) TWO-PHASE SULFATE REDUCTION DEVICE AND TREATMENT METHOD FOR PREVENTING SLUDGE CALCIFICATION

(71) Applicant: NANJING UNIVERSITY, Nanjing (CN)

(72) Inventors: Aimin LI, Nanjing (CN); Jun LI, Nanjing (CN); Yifan FENG, Nanjing (CN); Chunlei YANG, Nanjing (CN); Minhui CAI, Nanjing (CN); Yan LI, Nanjing (CN); Yang PAN, Nanjing (CN); Xun CHEN, Nanjing (CN)

(21) Appl. No.: 19/284,218

(22) Filed: Jul. 29, 2025

(30) Foreign Application Priority Data
Jul. 31, 2024 (CN) 202411038603.0

(51) Int. Cl. C02F 3/28; C02F 1/20; C02F 1/66; C02F 3/34; C02F 101/10; C02F 101/30

(52) U.S. Cl. CPC C02F 3/2873; C02F 1/20; C02F 1/66; C02F 3/284; C02F 3/286; C02F 3/345; C02F 2101/101; C02F 2101/30; C02F 2303/22

(57) ABSTRACT

The present application discloses a two-phase sulfate reduction device and treatment method for preventing sludge calcification, which belongs to the technical field of wastewater treatment in environmental engineering. The present application combines a two-phase sulfate reduction anaerobic reactor with an alloy catalyst, and reasonably arranges a two-phase connection unit of the alloy catalyst within the device body. By using the special functions of the porous alloy catalyst material to release free electrons into a body of water and polarize the body of water, the electrostatic potential of the body of water is changed, sludge calcification during the wastewater treatment process is prevented, and the treatment efficiency of the anaerobic system for sulfate organic wastewater is ensured.

### TECHNICAL FIELD

The present application belongs to the technical field of wastewater treatment in environmental engineering, and more specifically, relates to a two-phase sulfate reduction device and treatment method for preventing sludge calcification.

### BACKGROUND

In the papermaking industry, large amounts of sulfuric acid or sulfates are used during processes such as papermaking, pulp bleaching, and pulping, resulting in wastewater that typically contains high concentrations of sulfates. Anaerobic biological treatment technology is widely applied in the treatment of high-concentration organic wastewater due to its high energy recovery efficiency and high loading capacity. However, calcium carbonate is used as filler and coating material during production in the papermaking industry, leading to wastewater that also contains large amounts of calcium ions. During anaerobic biological treatment, calcium ions easily combine with carbonate or bicarbonate ions to form precipitates, which may adsorb into sludge pores, deposit within the sludge, or coat the sludge surface, which causes calcification of granular sludge, and reduces biological activity and settling performance of the granular sludge. In addition, sludge calcification affects the circulation system of anaerobic reactors, leading to reactor scaling and blockage, ultimately reducing the treatment efficiency of the anaerobic system.

Currently, methods used to control sludge calcification during anaerobic treatment of papermaking wastewater mainly include chemical precipitation, controlling the calcium precipitation process, and replacing calcified sludge. (i) The chemical precipitation method involves adding alkaline agents such as soda ash or sodium hydroxide before the wastewater enters the anaerobic system, so that Ca²⁺ forms insoluble salts and is removed in the form of precipitates, thereby lowering the Ca²⁺ concentration entering the anaerobic system and reducing sludge calcification. However, adding alkaline agents increases the alkalinity of the wastewater, which affects the anaerobic biological process, and the cost of reagents is high. (ii) Controlling the calcium precipitation process refers to adjusting the pH of the anaerobic system by acid addition to prevent Ca²⁺ from forming precipitates, and to reduce the retention rate of Ca²⁺. It also involves recirculating the effluent from the secondary sedimentation tank to dilute the influent of the anaerobic system, thereby lowering the Ca²⁺ concentration in the influent. Based on the mechanism of sludge calcification and the solubility product of calcium carbonate, pH and alkalinity are the main factors affecting calcium carbonate precipitation. A pH that is too high accelerates precipitation, while a pH that is too low leads to accumulation of volatile fatty acids, reactor acidification, and reduced activity of methane-producing microbes. Therefore, theoretically, adjusting pH by acid addition can reduce Ca²⁺ retention, but the operation is difficult, and improper pH control may adversely affect the treatment performance of the anaerobic system. Recirculating effluent from the secondary sedimentation tank can dilute the Ca²⁺ concentration in the influent and reduce Ca²⁺ retention in the anaerobic system, but it does not lower the total Ca²⁺ concentration in the influent, so it cannot eliminate the impact of Ca²⁺ on sludge calcification at the source and can only provide limited mitigation. (iii) Replacing calcified sludge involves timely removal of calcified sludge and replenishment with fresh sludge to prevent sludge calcification affecting the treatment performance of the anaerobic system. This method is simple to operate, but has problems such as high cost, difficulty in controlling sludge concentration, and long sludge cultivation periods.

Methods such as chemical precipitation, controlling calcium precipitation, and replacing calcified sludge have problems such as increasing alkalinity of the anaerobic system, affecting the anaerobic biological treatment process, and high cost. Therefore, there is an urgent need for a technique that is low-cost, energy-efficient, and requires no subsequent treatment that can prevent sludge calcification during the anaerobic process without affecting the anaerobic process.

### SUMMARY

### 1. Problems to be Solved

In response to the problems of sludge calcification, reactor blockage, and decreased treatment efficiency of the anaerobic system in existing sulfate wastewater treatment technologies, the present application provides a two-phase sulfate reduction device and treatment method for preventing sludge calcification. The present application combines a two-phase sulfate reduction anaerobic reactor with an alloy catalyst, and reasonably arranges a two-phase connection unit of the alloy catalyst within the device body. By using the special functions of the porous alloy catalyst material to release free electrons into a body of water and polarize the body of water, the electrostatic potential of the body of water is changed, sludge calcification during the wastewater treatment process is prevented, and the treatment efficiency of the anaerobic system for sulfate organic wastewater is ensured.

### 2. Technical Solution

To solve the above problems, the technical solution adopted in the present application is as follows:

A two-phase sulfate reduction device for preventing sludge calcification of the present application includes a device body, an internal circulation unit, and an alloy catalyst two-phase connection unit; the device body is internally configured from bottom to top with an acid-producing zone, a methane-producing zone, and a precipitation zone; an acid-producing zone three-phase separator is arranged at a top of the acid-producing zone; a methane-producing zone three-phase separator is arranged between the methane-producing zone and the precipitation zone;

The internal circulation unit comprises a cyclone gas-liquid separator, an exhaust pipe, an acid-producing zone riser pipe, a methane-producing zone riser pipe, and a reflux pipe; the cyclone gas-liquid separator is arranged at a top of the device body; the exhaust pipe is located at a top of the cyclone gas-liquid separator; the cyclone gas-liquid separator is connected to the acid-producing zone three-phase separator through the acid-producing zone riser pipe; the cyclone gas-liquid separator is connected to the methane-producing zone three-phase separator through the methane-producing zone riser pipe; the cyclone gas-liquid separator is connected to the methane-producing zone through the reflux pipe;

The alloy catalyst two-phase connection unit is arranged between the acid-producing zone and the methane-producing zone, and is used for connecting the acid-producing zone and the methane-producing zone; the alloy catalyst two-phase connection unit comprises a first alloy catalyst zone, a second alloy catalyst zone, and a U-shaped pipe; the first alloy catalyst zone is arranged within an influent pipe connected below the device body; the second alloy catalyst zone is arranged within the U-shaped pipe; the U-shaped pipe is arranged on a side wall of a reactor main body between the acid-producing zone and the methane-producing zone; one open end of the U-shaped pipe is connected to the acid-producing zone, and the other open end is connected to the methane-producing zone.

Preferably, a baffle is arranged between the acid-producing zone and the methane-producing zone, and the baffle is located between two open ends of the U-shaped pipe.

Preferably, the acid-producing zone, the methane-producing zone, and the precipitation zone have a volume ratio of 2:4:1.

Preferably, a pH adjustment port is arranged on a side of the U-shaped pipe.

Preferably, an overflow weir is arranged within the precipitation zone; an effluent outlet is arranged on an upper side surface of the precipitation zone; the overflow weir is located below the effluent outlet.

A two-phase sulfate reduction treatment method for preventing sludge calcification uses the above device for treatment. The treatment method specifically includes:
S1. Inoculating anaerobic sludge in the acid-producing zone and the methane-producing zone, introducing sulfate-containing organic wastewater into the acid-producing zone through the influent pipe to contact the sludge for degrading the organic matter in the wastewater, the sulfate-containing organic wastewater contacting porous alloy catalyst material in the first alloy catalyst zone inside the influent pipe; the porous alloy catalyst material releases free electrons into the sulfate-containing organic wastewater, neutralizes calcium and magnesium ions in a body of water, changes the electrostatic potential of the body of water, and prevents anaerobic sludge calcification in the acid-producing zone;
S2. Separating the wastewater treated in the acid-producing zone in the acid-producing zone three-phase separator, wherein retained sludge returns to the acid-producing zone, generated gas enters the cyclone gas-liquid separator through the acid-producing zone riser pipe, and effluent enters the methane-producing zone through the U-shaped pipe; in the U-shaped pipe, the effluent contacts the porous alloy catalyst material in the second alloy catalyst zone; under the action of the porous alloy catalyst material, calcification of anaerobic sludge in the acid-producing zone is further prevented;
S3. Introducing the effluent treated in step S2 into the methane-producing zone to further degrade the organic matter in the wastewater, and separating the wastewater treated in the methane-producing zone in the methane-producing zone three-phase separator; retained sludge returns to the methane-producing zone, generated gas enters the cyclone gas-liquid separator through the methane-producing zone riser pipe, and effluent is discharged after precipitation in the precipitation zone;
S4. Performing gas-liquid separation after the gas generated in steps S2 and S3 carrying mixed reaction liquids enters the cyclone gas-liquid separator, the gas discharging through the exhaust pipe, and the liquid returning to the methane-producing zone through the reflux pipe, realizing internal circulation of the mixed liquids in the methane-producing zone.

Preferably, the pH value of the acid-producing zone is 4.0 to 4.5, and the ratio of influent sodium bicarbonate to COD is controlled within 1/10 to 1/50.

Preferably, the first alloy catalyst zone or the second alloy catalyst zone is filled with porous alloy catalyst material accounting for 1/200 of the effective volume of the device body, and a flowrate of fluid contacting the porous alloy catalyst material is controlled at 1 m/s to 5 m/s.

Preferably, the effluent discharged in step S3 after being pH-adjusted is mixed with the wastewater treated in the acid-producing zone to enter the methane-producing zone, maintaining the pH value of the methane-producing zone at 6.8 to 8.5.

Preferably, the porous alloy catalyst material is a columnar crystal structure material composed of 30% to 50% Zn, 15% to 35% Cu, 10% to 30% Co, 5% to 20% Ni, 0.5% to 10% Fe, and 0.1% to 5% Sn by mass percentage.

### 3. Beneficial Effects

Compared with the prior art, the beneficial effects of the present application are as follows:
(1) The two-phase sulfate reduction device for preventing sludge calcification of the present application combines an alloy catalyst with a two-phase sulfate reduction anaerobic reactor. Porous alloy catalyst is arranged at the influent pipe and the two-phase connection of the device body. The water flow contacts the alloy catalyst at a flowrate of 1 m/s to 5 m/s. The alloy catalyst releases free electrons into the body of water, neutralizes calcium and magnesium cations in the body of water, changes the electrostatic potential of the body of water, and prevents sludge calcification inside the two-phase sulfate reduction device.
(2) In the two-phase sulfate reduction device for preventing sludge calcification of the present application, the acid-producing zone and the methane-producing zone are completely separated by a baffle. The effluent of the acid-producing zone, after being separated in the acid-producing zone three-phase separator, enters the methane-producing zone from the U-shaped pipe at the side wall under the action of upflow velocity. The volume ratio of the methane-producing zone to the acid-producing zone is 2:1, which not only increases the hydraulic retention time of the methane-producing zone and decreases the hydraulic retention time of the acid-producing zone, but also facilitates the acclimation of different microorganisms in different zones.
(3) The two-phase sulfate reduction treatment method for preventing sludge calcification of the present application controls the influent sodium bicarbonate/COD ratio within 1/10 to 1/50 and maintains the pH value of the acid-producing zone between 4.0 to 4.5, so that the acid-producing zone performs ethanol-type fermentation to provide ethanol for the methane-producing zone. The methane-producing zone then uses ethanol as a substrate to construct an in situ direct interspecies electron transfer system, promoting the methane-producing process and organic pollutant degradation.

### BRIEF DESCRIPTION OF THE DRAWINGS

FIG. 1 is a schematic structural diagram of a two-phase sulfate reduction device for preventing sludge calcification according to the present application;

In the FIGURE:
100: Device body; 101: Influent pipeline; 110: Acid-producing zone; 111: Acid-producing zone three-phase separator;
120: Methane-producing zone; 121: Methane-producing zone three-phase separator; 130: Precipitation zone; 131: Overflow weir;
132: Effluent outlet; 200: Internal circulation unit; 210: Cyclone gas-liquid separator; 220: Exhaust pipe;
230: Acid-producing zone riser pipe; 240: Methane-producing zone riser pipe; 250: Reflux pipe;
300: Alloy catalyst two-phase connection unit; 310: First alloy catalyst zone;
320: Second alloy catalyst zone; 330: U-shaped pipe;
340: pH adjustment port; 400: Baffle.

### DETAILED DESCRIPTION

The present application is further described below in conjunction with specific embodiments.

A two-phase sulfate reduction device for preventing sludge calcification of the present application combines an alloy catalyst with a two-phase sulfate reduction anaerobic reactor. The alloy catalyst material includes metals such as iron (Fe), cobalt (Co), nickel (Ni), and zinc (Zn) forming special columnar crystal structures, which can release free electrons into a body of water, neutralize positively charged ions such as calcium and magnesium in the body of water, change an electrostatic potential of the body of water, and significantly reduce a rate of sludge calcification, thereby achieving a scale-inhibiting effect.

### Embodiment 1

A target body of water treated in this embodiment is wastewater from a chemical company in Jiangsu. The water treatment capacity is 1000 t/d, and the influent calcium ion concentration is about 1714 mg/L. Pipe scaling and sludge calcification are severe, requiring replacement of pipes and granular sludge every six months, seriously affecting normal industrial production. Quality of the company's influent is shown in Table 1. Water quality is regularly monitored during treatment, and the average concentration values are taken.

TABLE 1
Water quality before and after treatment in Embodiment 1

| | | | | | Nitrate | Total |
|---|---|---|---|---|---|---|
| | COD | SO₄²⁻ | Ca²⁺ | Cl⁻ | nitrogen | nitrogen |
| | (mg/L) | (mg/L) | (mg/L) | (mg/L) | (mg/L) | (mg/L) |
| Influent | 5218 | 1970 | 1714 | 563 | 256 | 303 |
| Effluent | 231 | 136 | 1134 | 478 | 198 | 255 |

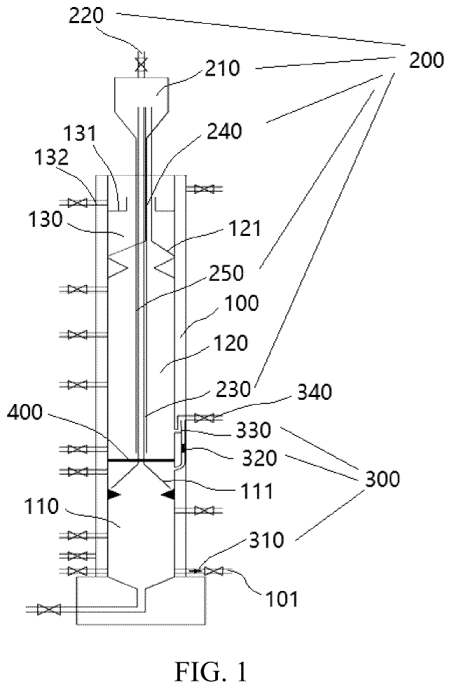

As shown in FIG. 1, the two-phase sulfate reduction device for preventing sludge calcification used in this embodiment includes a device body 100, an internal circulation unit 200, and an alloy catalyst two-phase connection unit 300. The device body 100 is internally configured from bottom to top with an acid-producing zone 110, a methane-producing zone 120, and a precipitation zone 130 in a volume ratio of 2:4:1. An acid-producing zone three-phase separator 111 is arranged at a top of the acid-producing zone 110. A methane-producing zone three-phase separator 121 is arranged between the methane-producing zone 120 and the precipitation zone 130. The internal circulation unit 200 includes a cyclone gas-liquid separator 210, an exhaust pipe 220, an acid-producing zone riser pipe 230, a methane-producing zone riser pipe 240, and a reflux pipe 250. The cyclone gas-liquid separator 210 is arranged at a top of the device body 100. The exhaust pipe 220 is located at a top of the cyclone gas-liquid separator 210. The cyclone gas-liquid separator 210 is connected to the acid-producing zone three-phase separator 111 through the acid-producing zone riser pipe 230. The cyclone gas-liquid separator 210 is connected to the methane-producing zone three-phase separator 121 through the methane-producing zone riser pipe 240. The cyclone gas-liquid separator 210 is connected to the methane-producing zone 120 through the reflux pipe 250. The alloy catalyst two-phase connection unit 300 is arranged between the acid-producing zone 110 and the methane-producing zone 120, and is used for connecting the acid-producing zone 110 and the methane-producing zone 120. A baffle 400 is arranged between the acid-producing zone 110 and the methane-producing zone 120, and the baffle 400 is located between two open ends of a U-shaped pipe 330. A pH adjustment port 340 is arranged on a side of the U-shaped pipe 330. The alloy catalyst two-phase connection unit 300 includes a first alloy catalyst zone 310, a second alloy catalyst zone 320, and the U-shaped pipe 330. The first alloy catalyst zone 310 is arranged within an influent pipe 101 connected below the device body 100. The second alloy catalyst zone 320 is arranged within the U-shaped pipe 330. The U-shaped pipe 330 is arranged on a side wall of a reactor main body between the acid-producing zone 110 and the methane-producing zone 120. One open end of the U-shaped pipe 330 is connected to the acid-producing zone 110, and the other open end is connected to the methane-producing zone 120. Furthermore, the device body 100 is arranged with an insulation layer and maintains an internal temperature of the device at 35±1° C. through water bath circulation.

The startup and phase separation processes of the device in this embodiment are as follows: a method combining pH regulation and kinetic control is used, wherein, pH regulation is to control the pH of the acid-producing zone 110 between 4.0 to 6.5. Considering the need for ethanol-type fermentation, the final pH of the acid-producing phase needs to be controlled between 4.0 to 4.5, while the methane-producing phase only needs to be maintained at a neutral to slightly alkaline pH. The principle of kinetic control is realized based on the growth rate difference between acid-producing bacteria and MPA. Acid-producing bacteria have a rapid growth rate, with short generation times generally within 10 to 30 minutes; in contrast, MPA has a relatively slow growth rate, with long generation times generally within 4 to 6 days. Therefore, by controlling HRT, the growth of bacteria in the reactor is optimized to achieve phase separation.

First, after the sludge acclimated at an HRT of 36 hours and achieved stable COD removal and sulfate reduction effects, influent OLR was increased by sequentially gradually shortening the HRT to 24 hours, 16 hours, 12 hours, 8 hours, and 6 hours. During the experiment, the pH of the acid-producing zone 110 was continuously monitored. When the pH was reduced to 4.0 to 4.5, the pH was ensured to remain in this range to achieve ethanol-type fermentation. If the pH fell below 4.0, the concentration of sodium bicarbonate in the influent was increased to buffer excess acidity in the acid-producing phase. At the same time, through the pH adjustment port 340, 20 g/L sodium bicarbonate solution was introduced into the methane-producing zone 120 to maintain the pH of the methane-producing zone 120 at 7.5 to 8.5, completing two-phase separation between the acid-producing zone 110 and the methane-producing zone 120.

The first alloy catalyst zone 310 and the second alloy catalyst zone 320 are equipped with porous alloy catalysts, and the elemental mass composition is Zn (37.25%), Cu (31.44%), Co (18.44%), Ni (5.22%), Fe (5.72%), and Sn (1.93%). The porous alloy catalyst is a cylindrical body, with a diameter of 8 cm and a length of 20 cm, with multiple channels along an axis of the cylindrical body to increase a contact surface area between the catalyst and the water flow. The alloy catalyst material possesses special functions of releasing free electrons into a fluid medium and inducing polarization in the fluid medium. When wastewater flows at a certain speed through the alloy catalyst material, the material can release free electrons into the wastewater, induce polarization in the fluid, neutralize calcium and magnesium ions in the body of water, and change an electrostatic potential of the body of water, preventing anaerobic sludge calcification in the acid-producing zone 110 and the methane-producing zone 120. During operation of the device, external circulation was increased for the methane-producing zone 120 to maintain an up-flow velocity of about 1 m/h, causing the granular sludge within the reactor to adopt a fluidized state, making it difficult to develop sludge calcification.

After one year of stable operation, granular sludge in the device and granular sludge from an IC reactor used by the company that had treated the same wastewater for one year were taken for analysis and testing, including characterizing the concentration of organic components in the sludge by mixed liquor suspended solids (MLSS) and mixed liquid volatile suspended solids (MLVSS), characterizing particle size distribution by a particle size analyzer, and characterizing calcium concentration by an energy dispersive spectrometer (EDS). Results are shown in Table 2.

TABLE 2
Physicochemical properties and elemental concentrations
of granular sludge from the device of Embodiment 1

| | | | MLVSS/MLSS | Calcium | Particle size |
|---|---|---|---|---|---|
| | MLSS | MLVSS | (organic | concentration | Dₓ (50) |
| | (g/L) | (g/L) | components) | (%) | (μm) |
| Granular sludge of | 81.30 | 66.59 | 0.82 | 0.15 | 1020 |
| device from | | | | | |
| Embodiment 1 | | | | | |
| Granular sludge of IC | 84.96 | 56.07 | 0.66 | 9.54 | 1640 |
| reactor | | | | | |

In this embodiment, the concentration of organic components (MLVSS/MLSS) of granular sludge from the traditional IC reactor after one year of operation was only 66%, while the granular sludge of the two-phase sulfate reduction device for preventing sludge calcification reached 82%. This is because the organic matter in the traditional IC reactor was oxidized to generate CO₂, which was partially converted to carbonate and then formed white CaCO₃ precipitate with Ca²⁺ in the system, which attached to the surface of granular sludge, reducing the organic content of the sludge, increasing corresponding ash content, and causing sludge calcification. In contrast, the alloy catalyst material can release free electrons into the body of water when flowing therethrough, causing fluid polarization, neutralizing calcium and magnesium ions, and changing the electrostatic potential of the body of water, thereby preventing sludge calcification. The sludge particle size test results showed that calcified granular sludge had significantly increased particle size. In the device of this embodiment, the granular sludge particle size was 1020 μm, while the granular sludge from the traditional IC reactor had an average sludge particle size reaching 1640 μm. In addition, the EDS test results showed that the calcium concentration of granular sludge from the traditional IC reactor after operating for one year reached 9.54%, developing significant calcification. In contrast, the calcium ion concentration in the device of this embodiment was only 0.15%, with no calcification occurring.

Using the device of this embodiment to treat chemical wastewater, COD removal rate and sulfate reduction rate of the system were both over 80%, and no further sludge calcification occurred. At present, no replacement of pipes or granular sludge has been required after one year of operation.

### Embodiment 2

The basic contents of the device structure in this embodiment are the same as in Embodiment 1. The difference is that in the treatment method of this embodiment, due to higher COD, sulfate, and calcium ion concentration in the influent, the amount of alloy catalyst needs to be increased. In addition, during phase separation, the HRT of the acid-producing phase should not be too low; otherwise, neutralizing excess acidity will require large amounts of sodium bicarbonate reagent, increasing operating costs. Sodium bicarbonate and sodium hydroxide can be used together to adjust the pH of the acid-producing zone 110 and the methane-producing zone 120. Because the sulfate concentration in the influent is high, the pH of the methane-producing phase needs to be controlled within a higher range of pH 7.5 to 8.5 to reduce the toxicity inhibition effect of the sulfate reduction product hydrogen sulfide.

The target body of water treated in this embodiment is wastewater of a food company in Henan. The water treatment capacity is 1150 t/d, and the COD, sulfate, and calcium ion concentration are 12455 mg/L, 3847 mg/L, and 3345 mg/L, respectively. Previously, sludge calcification during the wastewater treatment process was severe, and the company had to replace a batch of sludge every 3 months to alleviate the sludge calcification phenomenon.

The startup and phase separation processes of the device in this embodiment are as follows: a method combining pH regulation and kinetic control is used. Seeded sludge in the device was from a distillery in Henan that treated sodium citrate wastewater. The sludge has good properties and a high degree of granulation. First, after the sludge acclimated at an HRT of 48 hours and achieved stable COD removal and sulfate reduction effects, influent OLR was increased by sequentially gradually shortening the HRT to 40 hours, 32 hours, 24 hours, 18 hours, 14 hours, and 10 hours. During the experiment, the pH of the acid-producing zone 110 was continuously monitored. When the pH was reduced to 4.0 to 4.5, the pH was maintained within this range. If the pH dropped below 4.0, the concentration of sodium bicarbonate and sodium hydroxide (1:1) in the influent was increased to buffer excess acidity in the acid-producing phase. At the same time, through the pH adjustment port 340, a 20/20 g/L sodium bicarbonate/sodium hydroxide solution was introduced into the methane-producing zone 120 to maintain the pH of the methane-producing zone 120 within 7.5 to 8.5, completing the two-phase separation between the acid-producing zone 110 and the methane-producing zone 120.

The first alloy catalyst zone 310 and the second alloy catalyst zone 320 are equipped with porous alloy catalysts, and the elemental mass composition is Cu (34.19%), Zn (33.35%), Co (15.46%), Ni (12.25%), Fe (2.72%), and Sn (2.03%). The porous alloy catalyst is a cylindrical body, with a diameter of 8 cm and a length of 40 cm, with multiple channels along an axis of the cylindrical body to increase a contact surface area between the catalyst and the water flow. When wastewater flows at a certain speed through the alloy catalyst material, the material can release free electrons into the wastewater, induce polarization in the fluid, neutralize calcium and magnesium ions in the body of water, and change an electrostatic potential of the body of water, preventing anaerobic sludge calcification in the acid-producing zone 110 and the methane-producing zone 120.

Using the device and method of this embodiment to treat the high-sulfate, high-calcium wastewater from the food company in Henan, the system achieved a COD removal rate of over 90% and a sulfate reduction rate of 85%, with no occurrence of sludge calcification. At present, no replacement of pipes or granular sludge has been required after one year of operation.

### Embodiment 3

The basic contents of the device structure in this embodiment are the same as in Embodiment 1. The difference is that in the treatment method of this embodiment, due to the low organic load in the influent, the kinetic control method cannot reduce the pH value of the acid-producing zone 110 to 4.0 to 4.5. Therefore, sulfuric acid needs to be added during the startup process to assist in adjusting the pH value of the acid-producing zone 110.

The target body of water treated in this embodiment is wastewater from a papermaking company in Nanjing. The water treatment capacity is 1500 t/d, and the COD, sulfate, and calcium ion concentration are 1217 mg/L, 628 mg/L, and 1024 mg/L, respectively. Previously, sludge calcification and pipe scaling during the wastewater treatment process were severe, and the company had to replace the pipes and granular sludge once a year.

The startup and phase separation processes of the device in this embodiment are as follows: a method combining pH regulation and kinetic control is used. Seeded sludge in the device was from a distillery in Jiangsu that treated sodium citrate wastewater. The sludge has good properties and a high degree of granulation. First, after the sludge acclimated at an HRT of 36 hours and achieved stable COD removal and sulfate reduction effects, the influent OLR was increased by gradually shortening the HRT to 24 hours, 16 hours, 12 hours, 8 hours, and 6 hours. During the experiment, the pH of the acid-producing zone 110 was continuously monitored, and a certain amount of sulfuric acid was added to the influent to adjust the pH to 4.0 to 4.5. At the same time, through the pH adjustment port 340, a 20 g/L sodium bicarbonate solution was introduced into the methane-producing zone 120 to maintain the pH of the methane-producing zone 120 within 6.8 to 7.5, completing the two-phase separation between the acid-producing zone 110 and the methane-producing zone 120.

The first alloy catalyst zone 310 and the second alloy catalyst zone 320 are equipped with porous alloy catalysts, and the elemental mass composition is identical to that of Embodiment 2. The porous alloy catalyst is a cylindrical body, with a diameter of 8 cm and a length of 10 cm, with multiple channels along an axis of the cylindrical body to increase a contact surface area between the catalyst and the water flow. The alloy catalyst material possesses special functions of releasing free electrons into a fluid medium and inducing polarization in the fluid medium. When wastewater flows at a certain speed through the alloy catalyst material, the material can release free electrons into the wastewater, induce polarization in the fluid, neutralize calcium and magnesium ions in the body of water, and change an electrostatic potential of the body of water, preventing anaerobic sludge calcification in the acid-producing zone 110 and the methane-producing zone 120.

Using the device and method of this example to treat wastewater from the papermaking company in Nanjing, the system achieved a COD removal rate of over 90% and a sulfate reduction rate of 75%, with no occurrence of sludge calcification. At present, no replacement of pipes or granular sludge has been required after one and a half years of operation.

The above description only refers to partial embodiments of the present application and does not constitute any formal or substantive limitation to the present application. It should be noted that for those of ordinary skill in the art, several improvements and additions may be made without departing from the methods of the present application, and these improvements and additions should also be regarded as within the scope of protection of the present application. Likewise, without departing from the creative spirit of the present application, structural modes and embodiments that are similar to the technical solution but do not involve inventive design shall also fall within the scope of protection of the present application.

What is claimed is:

1. A two-phase sulfate reduction device for preventing sludge calcification, comprising a device body (100), an internal circulation unit (200), and an alloy catalyst two-phase connection unit (300); characterized by: the device body (100) is internally configured from bottom to top with an acid-producing zone (110), a methane-producing zone (120), and a precipitation zone (130); the acid-producing zone (110), the methane-producing zone (120), and the precipitation zone (130) have a volume ratio of 2:4:1; an acid-producing zone three-phase separator (111) is arranged at a top of the acid-producing zone (110); a methane-producing zone three-phase separator (121) is arranged between the methane-producing zone (120) and the precipitation zone (130);
the internal circulation unit (200) comprises a cyclone gas-liquid separator (210), an exhaust pipe (220), an acid-producing zone riser pipe (230), a methane-producing zone riser pipe (240), and a reflux pipe (250); the cyclone gas-liquid separator (210) is arranged at a top of the device body (100); the exhaust pipe (220) is located at a top of the cyclone gas-liquid separator (210); the cyclone gas-liquid separator (210) is connected to the acid-producing zone three-phase separator (111) through the acid-producing zone riser pipe (230); the cyclone gas-liquid separator (210) is connected to the methane-producing zone three-phase separator (121) through the methane-producing zone riser pipe (240); the cyclone gas-liquid separator (210) is connected to the methane-producing zone (120) through the reflux pipe (250);
the alloy catalyst two-phase connection unit (300) comprises a first alloy catalyst zone (310), a second alloy catalyst zone (320), and a U-shaped pipe (330); the first alloy catalyst zone (310) is arranged within an influent pipe (101) connected below the device body (100); the second alloy catalyst zone (320) is arranged within the U-shaped pipe (330);
the U-shaped pipe (330) is arranged on a side wall of a reactor main body between the acid-producing zone (110) and the methane-producing zone (120); one open end of the U-shaped pipe (330) is connected to the acid-producing zone (110), and the other open end is connected to the methane-producing zone (120); the acid-producing zone (110) is connected to the methane-producing zone (120) through the U-shaped pipe (330); the effluent of the acid-producing zone (110) enters the methane-producing zone (120) through the U-shaped pipe (330);
a baffle (400) is arranged between the acid-producing zone (110) and the methane-producing zone (120), and the baffle (400) is located between two open ends of the U-shaped pipe (330);
a pH adjustment port (340) is arranged on a side of the U-shaped pipe (330); the pH value of the acid-producing zone (110) is 4.0 to 4.5; the pH value of the methane-producing zone (120) is 6.8 to 8.5;
the first alloy catalyst zone (310) and the second alloy catalyst zone (320) is filled with porous alloy catalyst material, and the porous alloy catalyst material is a cylindrical body material composed of 30% to 50% Zn, 15% to 35% Cu, 10% to 30% Co, 5% to 20% Ni, 0.5% to 10% Fe, and 0.1% to 5% Sn by mass percentage; multiple channels are arranged along an axial direction of the cylindrical body to increase a contact surface area between the catalyst and the water flow.

2. The two-phase sulfate reduction device for preventing sludge calcification according to claim 1, characterized in that: an overflow weir (131) is arranged within the precipitation zone (130); an effluent outlet (132) is arranged on an upper side surface of the precipitation zone (130); the overflow weir (131) is located below the effluent outlet (132).

3. A two-phase sulfate reduction treatment method for preventing sludge calcification, characterized by using the device according to claim 1 for treatment, the treatment method specifically comprising:
S1. inoculating anaerobic sludge in the acid-producing zone and the methane-producing zone, introducing sulfate-containing organic wastewater into the acid-producing zone through the influent pipe with a flowrate of fluid at 1 m/s to 5 m/s to contact the sludge for degrading the organic matter in the wastewater, the sulfate-containing organic wastewater contacting porous alloy catalyst material flows through the first alloy catalyst zone inside the influent pipe; the porous alloy catalyst material releases free electrons into the sulfate-containing organic wastewater, neutralizes calcium and magnesium ions in a body of water, changes the electrostatic potential of the body of water, and prevents anaerobic sludge calcification in the acid-producing zone;
S2. separating the wastewater treated in the acid-producing zone in the acid-producing zone three-phase separator, wherein retained sludge returns to the acid-producing zone, generated gas enters the cyclone gas-liquid separator through the acid-producing zone riser pipe, and effluent enters the methane-producing zone through the U-shaped pipe; in the U-shaped pipe, the effluent contacts the porous alloy catalyst material in the second alloy catalyst zone; under the action of the porous alloy catalyst material, calcification of anaerobic sludge in the acid-producing zone is further prevented;
S3. introducing the effluent treated in step S2 into the methane-producing zone to further degrade the organic matter in the wastewater, and separating the wastewater treated in the methane-producing zone in the methane-producing zone three-phase separator; retained sludge returns to the methane-producing zone, generated gas enters the cyclone gas-liquid separator through the methane-producing zone riser pipe, and effluent is discharged after precipitation in the precipitation zone;
S4. performing gas-liquid separation after the gas generated in steps S2 and S3 carrying mixed reaction liquids enters the cyclone gas-liquid separator, the gas discharging through the exhaust pipe, and the liquid returning to the methane-producing zone through the reflux pipe, realizing internal circulation of the mixed liquids in the methane-producing zone;
the first alloy catalyst zone or the second alloy catalyst zone is filled with porous alloy catalyst material accounting for 1/200 of the effective volume of the device body.

4. The two-phase sulfate reduction treatment method for preventing sludge calcification according to claim 3, characterized in that: the pH value of the acid-producing zone is 4.0 to 4.5, and the ratio of influent sodium bicarbonate to COD is controlled within 1/10 to 1/50.

5. The two-phase sulfate reduction treatment method for preventing sludge calcification according to claim 3, characterized in that: the effluent discharged in step S3 after being pH-adjusted is mixed with the wastewater treated in the acid-producing zone to enter the methane-producing zone, maintaining the pH value of the methane-producing zone at 6.8 to 8.5.
